(19) United States
(12) Patent Application Publication
(10) Pub. No.: US 2004/0012217 A1
(43) Pub. Date: Jan. 22, 2004

(54) End effector

(76) Inventors: Richard E. Shafer, Webster, TX (US); William C. Robertson, Houston, TX (US)

Correspondence Address: Kurt S. Myers, 7634 Braesdale, Houston, TX, 77071, US

(21) Appl. No.: 10/198,439

(22) Filed: Jul. 18, 2002

(51) Int. Cl. B25J 15/12

(52) U.S. Cl. 294/100; 294/86.4

(57) ABSTRACT

The present invention is directed to an end effector, a gripper, that retrieves crystals that are mounted on cryo-pins from a storage location in liquid nitrogen. More specifically, the end effector of the present invention is a collet type of gripping mechanism.

### RELATED APPLICATION

This application is based on provisional application No. 60/302,657, filed Jul. 19, 2001, entitled “Robotic End Effector for Handling of Hairloop Mounted Crystal Samples”.

### FIELD OF THE INVENTION

The present invention is directed to an end effector that grasps the outer diameter of a cyro-pin—the device in which the crystal is typically mounted and the end effector is adapted to be connected to a robotic arm for movement of the cyro-pin from one location to another.

### BACKGROUND OF THE INVENTION

The production of crystals (especially protein crystals), the handling of crystals and x-ray diffraction of the crystals has been a manual operation. However, the need to produce and evaluate larger and larger numbers of crystals has required the manual methodology and techniques to be changed. In the production of crystals, the crystals are recovered on or mounted to a hairloop at the end of a cyro-pin, which usually is a metal rod. The cyro-pins, with the crystals on the hairloops, are stored in a cryogenic storage device that is cooled by liquid nitrogen. It has been the practice to move the cyro-pins and crystals by hand to a goniometer to carry out the x-ray diffraction on the crystal. After the x-ray diffraction procedure, the crystals and cryo-pins have been moved by hand back into the storage device.

### SUMMARY OF THE INVENTION

The present invention is directed to an end effector, a gripper, that retrieves crystals that are mounted on cyro-pins from a storage location in liquid nitrogen. More specifically, the end effector of the present invention is a collet type of gripping mechanism.

### BRIEF DESCRIPTION OF THE DRAWINGS

FIG. 1 is the end effector of the present invention mounted on the end of a robotic arm mechanism placing a crystal in a goniometer for x-ray diffraction;

FIG. 2 is an isometric view of the end effector of the present invention;

FIG. 3 is an isometric view of the collar of the collar clamp mechanism;

FIG. 4 is a cross-sectional view of the end effector of the present invention; and

FIG. 5 is a cross-section of the hollow collet of the end effector with a cryogenic metallic foam insert cylinder inside the tip.

### BRIEF DESCRIPTION OF THE PREFERRED EMBODIMENTS

The end effector or gripper of the present invention is designed to retrieve crystals that are mounted to cryo-pins from a storage location. Cryo-pins are well known, such as the Hampton Research, Oxford or Yale cryo-pins, having a metal rod or base with a hairloop on one end in which the crystal is mounted. Because the base of the cryo-pin is ferrous metal, the pins are easily retained in a storage device or other manipulative device that have magnetic bosses. The magnetic boss maintains a firm location of the pin when released by the end effector. The storage device is maintained at cryogenic temperatures usually by the use of liquid nitrogen. The cryo-pins are stored in the storage device (dewar) with the base of the cryo-pins down and the crystal mounted on the hairloop up. The dewars contain liquid nitrogen which maintains the integrity of the crystals.

A primary study of the crystals, such as new protein crystals, is accomplished by x-ray diffraction. The crystal is placed on a goniometer, a device that provides movement of the crystal in multiple axes to align the crystal in the X-ray beam. X-ray diffraction using a goniometer is well known and is used in combination with CCD cameras and other imaging devices to determine the structure or identify the composition of a crystal.

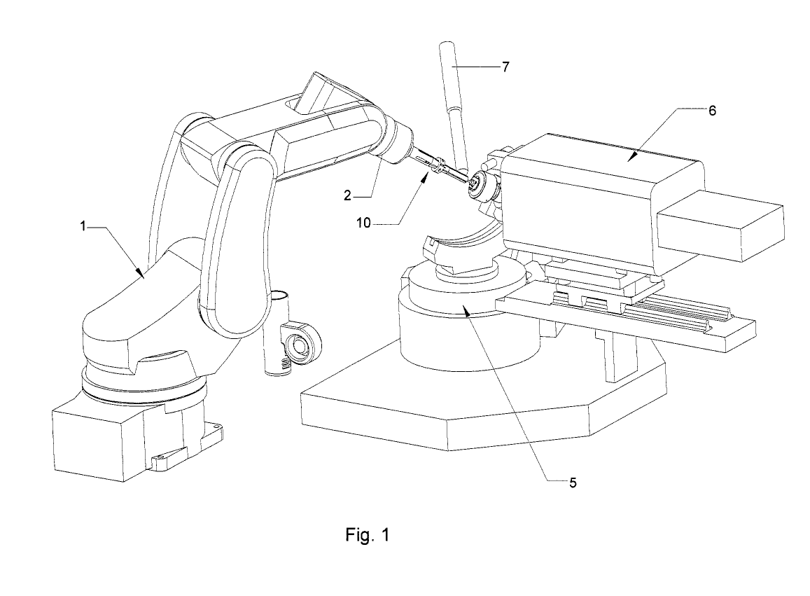

Referring now to FIG. 1, a robotic arm 1 has an end effector 10 attached to arm interface 2. The end effector 10 has removed a cryo-pin 4, not seen in FIG. 1, from a storage device (not shown) and is placing the crystal mounted on the pin on a goniometer 5. An imaging system 6 then records x-ray diffraction data which is related to the structure of the crystal. A nitrogen source 7 supplies chilled gaseous nitrogen to the crystal when mounted on the goniometer 6 to maintain the desired crystal temperature and to prevent condensation and ice from forming on the crystal.

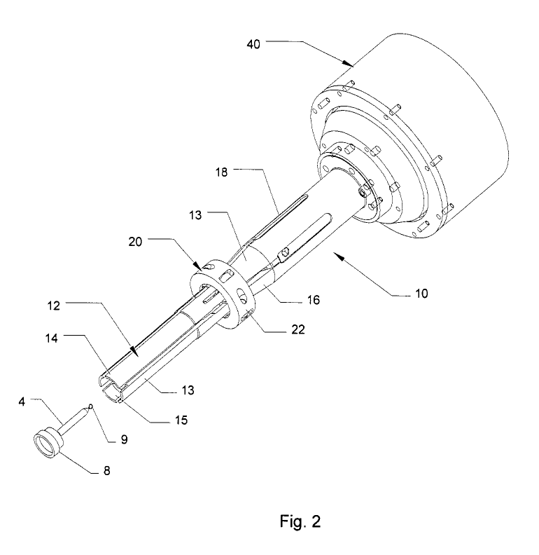

Referring to FIG. 2, a preferred embodiment of the end effector 10 is shown. The end effector 10 is shown with a cryo-pin 4 with the magnetic base 8 at the base of the pin 4. End effector 10 has a collet or chuck member 12 that surrounds pin 4 for movement of the crystal mounted on the hairloop 9. Collet 12 has three sections: a collet tip 14 having an open end 15; a tapered portion 16 where the outside diameter is tapered from the tip 14; and a thin-walled, flexible portion 18 where the outside diameter is larger than the tip 14. The collet 12 is tine-like and has a plurality of slender, projecting fingers 13, which create a cylindrical chamber when closed. The fingers 13 extend from the resilient portion 18 to the open end 15 of the collet tip 14. The end of fingers 13 are shaped on their inner surface such that they grip the base 8 of the cryo-pins 4.

The tine-like structure of the collet 12 forms a hollow, flexible collet or chuck for gripping the cryo-pin base 8. The collet tip 14 is sufficiently long to completely surround the pin 4 and crystal mounted thereon. The length of the collet 12 is such that it can be partially submerged in the liquid nitrogen of the storage device. The working components are sufficiently removed from direct contact with the liquid nitrogen. A collar clamp mechanism 20 that includes a collar 22 having rollers or bearings (not shown) on the inner surface reacts against the tapered portion 16 to either contract or reduce the size of the hollow opening for gripping the cryo-pin base 8 or opening the collet tip 14 to release the cyro-pin base 8.

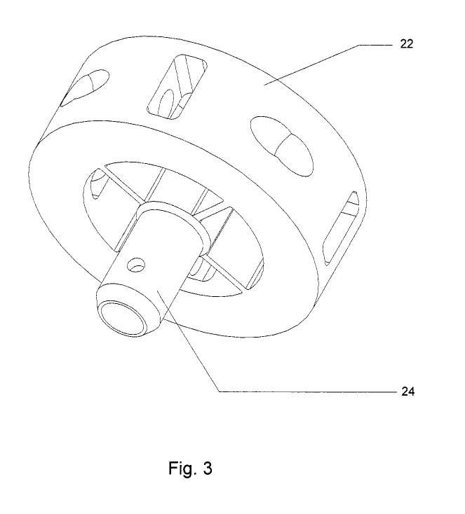

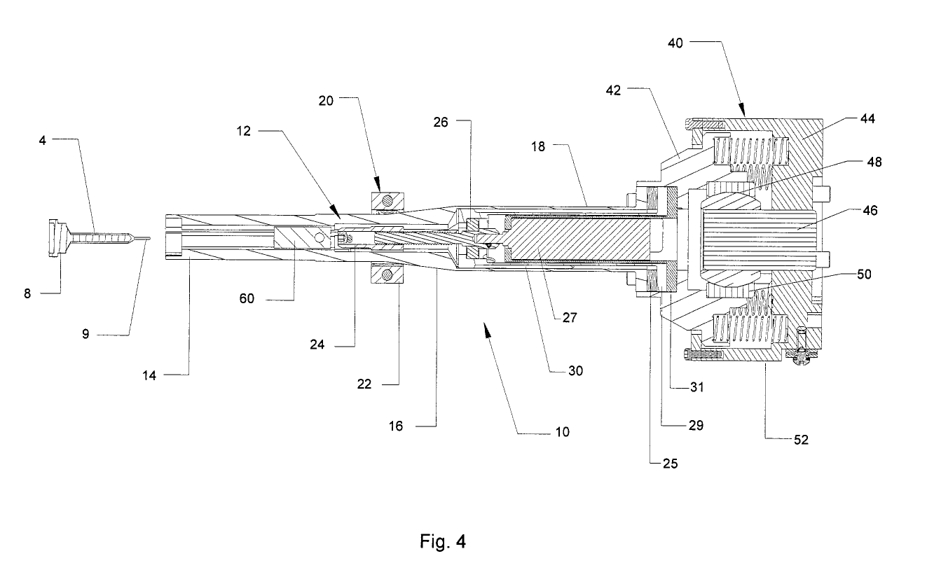

The details of the collar clamp mechanism 20 are best shown in the isometric view of the collar 22, FIG. 3, and the cross-sectional view of the end effector 10, FIG. 4. The collar 22 is machined as a one piece-part with an inter ring or nut 24. The nut 24 is internally threaded and the entire collar 22 moves axially on the collet 12 as a unit. A motor/gearbox assembly 27 has a thrust bearing 26, which reacts to the axial loading to protect the motor/gearbox assembly. Attached to the motor/gearbox 27 is a leadscrew 28 whose threads mesh with the threads in nut 24 and when rotated moves the collar 22/and nut 24 axially. As the collar 22 is moved up the inclined plane of section 16, the collar 22 and more specifically the rollers inside the collar 22 cause the collet tip 14 to close. The tip 14 is shaped such that when closed, the cryo-pin base 8 is grasped. Movement of the collar 22 down the inclined plane causes the collet tip 14 to open. There are sensors located in the end effector which are used to detect the open and close position to ensure optimal grasping of the cryo-pin base 8.

In the flexible portion of collet 18, there is a motor housing 30 that is between the wall of the flexible portion 18 and the motor/gearbox 27. The collet tip 14 extends several inches from the collar 22 to allow the tip 14 to be immersed in the liquid nitrogen, while the higher stressed portion of the collet 12 that flexes and the motor/gearbox 27 remains protected from the extreme cold of the liquid nitrogen. Metals such as stainless steel, with relatively low thermal conduction, are used to make the fingers 13, and a polymer thermal insulation disk 29 located between the bearing hanger 25 and the motor mount 31 of the motor housing provides a tortuous conductive path to the drive components.

Because of the fragile nature of the precision components and crystal specimens, a compliant member 40 may be added between the base of the end effector 10 and the mounting plate on the robot. The compliant member 40 includes an interface plate 42, facing and connected to collet 12, and a back shell 44. A shaft 46 is axially aligned with the collet 12 and is attached rigidly to the shell or housing 44. Surrounding shaft 46 are the inner race 48 and outer race 50 of a spherical bearing. The outer race 50 of the spherical bearing is attached to interface plate 42. As the outer race 50 of the spherical bearing moves with respect to its inner race 48, the end effector 10 may move in an axial and/or radial direction in a series of planes parallel to or non-parallel to the base 52 of the shell 44. When the end effector 10 deflects axially or otherwise, the spherical bearing moves down the shaft 46 and a sensor inside the compliance member 40 triggers an emergency stop on the arm 1 controller. This feature is intended to protect both equipment (crystals as well as system hardware) and personnel.

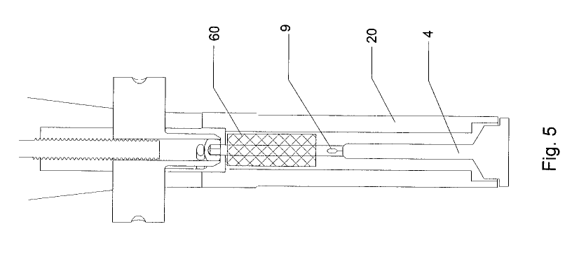

A significant enhancement to increase the thermal protection of the crystal mounted on the cryo-pin 4 when in collet 12 is an insert 60 below the collar 22 and above the cyro-pin 4 and the crystal mounted on the hairloop 9. The insert 60 is a small cylindrical piece of metal foam, which can be seen in both FIG. 4 and FIG. 5. When the collet 12 is immersed in the liquid nitrogen of the dewar, a small amount of the liquid nitrogen wicks into the retainer foam. The placement of the retainer 60 in the collet 12 provides a flow of chilled gaseous nitrogen while the crystal is being moved from the storage device to the goniometer 5 and provides a shield from the radiant heat energy from the warm upper portion of the collet 12.

1. An end effector for moving a cryo-pin comprising:
a collet having at one end a hollow open collet tip and at the other end a thin-walled flexible portion;
collar clamp provides mechanism for closing or opening said collet tip to grip or release a cryo-pin; and
a compliant member connected to said collet to provide emergency stop of system when deflection of said collet tip is detected. This is implemented as a safety feature to prevent damage due to unavoidable or inadvertent collisions.

2. An end effector according to claim 1 wherein said collet tip has a tapered outside portion of said collet tip at one end.

3. An end effector according to claim 2 that further comprises:
a threaded nut inside said collar to provide actuation of said collet tip; and
a motor having a threaded leadscrew which engages said threaded nut such that on rotation of said shaft said nut and collar move axially of said collet tip.

4. An end effector according to claim 1 that further comprises:
a cyrogenic liquid retainer in said collet tip at the end opposite said open end and located directly above a cryo-pin.

5. An end effector for moving a cryo-pin comprising;
a collet having at one end a hollow flexible collet tip, said tip having a tapered outside portion of said collet tip outer diameter at one end and being open at said other end;
a collar surrounding said collet tip that moves on said tapered portion of said collet tip;
a threaded nut inside said collar clamp; and
a motor/gearbox having a threaded leadscrew which engages said threaded nut such that on rotation of said leadscrew said nut and collar move axially on said collet tip.

6. An end effector according to claim 5 that further comprises:
a compliant member connected to said collet to provide deflection of said collet tip.

7. An end effector according to claim 5 that further comprises:
a cryogenic liquid retainer in said collet tip at the end opposite said open end.

8. An end effector for moving a cryo-pin comprising;
a collet having at one end a hollow flexible collet tip, said tip being open at one end for gripping a cryo-pin;
means for closing or opening said collet tip to grip or release said cryo-pin; and
a cryogenic liquid retainer in said collet tip at the end opposite said open end.

9. An end effector according to claim 8 wherein said means for contracting or opening said collet tip to grip or release said cryo-pin includes:
a collar clamp surrounding said collet tip;
a threaded nut inside said collar (collar and nut are machined such that they are both members of a single piece part); and
a motor/gearbox having an attached leadscrew which engages said threaded nut such that on rotation of said leadscrew said nut and collar move axially over said collet tip.

10. An end effector according to claim 8 that further comprises:
a compliant member connected to said collet to provide deflection of said collet tip.
A sensor inside the compliant mechanism triggers an emergency-stop for the system controller when the end effector is deflected.

11. An end effector according to claim 10 that further comprises:
means for attaching said compliant member to a robotic arm.
